(19) United States
(12) Patent Application Publication
(10) Pub. No.: US 2006/0089218 A1
(43) Pub. Date: Apr. 27, 2006

(54) Large torque diverting device for an engine transmission system

(75) Inventors: Huei-Huay Huang, Tainan City (TW); Weily Chen, Tainan Hsien (TW)

Correspondence Address: BACON & THOMAS, PLLC, 625 SLATERS LANE, FOURTH FLOOR, ALEXANDRIA, VA, 22314, US

(73) Assignee: Aeon Motor Co., Ltd., Tainan Hsien (TW)

(21) Appl. No.: 10/973,439

(22) Filed: Oct. 27, 2004

(51) Int. Cl. F16H 59/00; B02C 17/08

(52) U.S. Cl. 474/17; 474/8

(57) ABSTRACT

A large torque diverting device for an engine transmission system includes a cylinder between a bowl-shaped disc and a drive shaft. The cylinder rotates the drive shaft, which then rotated the rear wheels. The cylinder has plural insert grooves and the bowl-shaped also has plural ball holes to correspond to one another for steel balls to fit therein. When the drive shaft and the rear wheels receive a too large load or shock, and if the cylinder and drive shaft becomes deadlocked immovable, with the bowl-shaped disc still rotating, the bowl-shaped disc pushes a push ring to compress an elastic member to force instantly the steel balls separate from the cylinder to instantly release the large torque so as to protect the transmission gears and the shell from damaged, cracked or broken.

### BACKGROUND OF THE INVENTION

1. Field of the Invention

This invention relates to a large torque diverting device for an engine transmission system, particularly to one, which enables the transmission system to divert a large load or too large shock that the output end receives so as to prevent the transmission gears or the shell from damaged, cracked, or broken.

2. Description of the Prior Art

A conventional engine transmission system is shown in FIGS. 1, 2, including a drive shaft 10 for indirectly drive rear wheels 11, a belt wheel 20, a clutch 30, and a bowl-shaped disc 40.

The belt wheel 20 is fixed around an outer portion of the drive shaft 10 by means of a bearing, with a belt 21 extending around the belt wheel 20 and the drive shaft of an engine so as to rotate the belt wheel 20. The belt wheel 20 has one of its surfaces formed as a movable surface 22, which can be driven by the belt 21 and at the same time pushed to shift back and forth.

The clutch 30 is fixed around the outer portion of the drive shaft 10 by means of a bearing and located at the side of the movable surface 22 of the belt wheel 20. Then when the movable surface 22 is moved to shift forward, it becomes combined with the clutch 30, forcing the clutch 30 rotate as integral with the same speed of the belt wheel 20. As the clutch 30 produces centrifugal function during rotating, a horseshoe-shaped connect member 31 pivotally connected with the clutch 30 and having frictional functions may be expanded outward.

The bowl-shaped disc 40, as shown in FIG. 2, is fixed around the drive shaft 10, receiving the clutch 30 in its interior, and an intermediate cylinder 41 is provided between the disc 40 and the drive shaft 10, welded together with the disc 40. The cylinder 41 is combined with the drive shaft 10 by means of teeth and grooves so that the disc 40 can rotate synchronously with the drive shaft 10 via the cylinder 41. Therefore, when the clutch 30 rotates, the frictional horseshoe side of the connect member 31 expands outward to frictionally contact the inner wall of the disc 40 to rotate the disc 40. Then the disc 40 rotates the drive shaft 10 together.

In using, the engine is started with gas added, and with the belt 21 moved to rotate the belt wheel 20 and at the same time pushing the movable surface 22 to shift nearer and contact with the clutch 30 to rotate together. As the clutch 30 rotates, the connect member 31 will contact frictionally with the disc 40 because of centrifugal function so the disc 40 may rotate. Then the disc 40 rotates the drive shaft 10 and the rear wheels 11 so the engine power is transmitted to the rear wheels 11, which then rotate to let the automobile run forward.

However, the conventional engine transmission system has a drawback that in case the rear wheels 11 (or the output side) receives too large load, and becomes deadlocked immovable, with the gas being continuously added to the engine, the drive shaft 10 is kept rotating to let its output torque impossible to be released and become a shocking force, which may damage, crack or break the transmission gears and the shell.

### SUMMARY OF THE INVENTION

The purpose of the invention is to offer a large torque diverting device for an engine transmission system for instantly releasing large torque in case of the output side of the transmission system receives an excessive load so that the transmission gears or the shell may be protected from damaged, cracked or broken.

The large torque diverting device includes an intermediate cylinder and a bowl-shaped disc combined in such a special way that the cylinder has a flange on its outer surface and a plural semi-circular insert grooves spaced apart in an inner surface of the flange wall facing the bowl-shaped disc, and the bowl-shaped disc is provided with plural ball holes to correspond to the insert grooves, and a steel ball is fitted in each of the ball holes. The bowl-shaped disc has its rear side pushed by an elastic member so as to push a push ring, which then pushes the steel balls to partly insert in the insert grooves of the cylinder so the bowl-shaped disc and the cylinder rotate together as integral. Then the cylinder further rotates a drive shaft, which then rotates rear wheels. But if the drive shaft or the rear wheels receives a large load or shock and the cylinder and the drive shaft become deadlocked immovable with the bowl-shaped disc still rotates, the steel balls is moved by the bowl-shaped disc to push the push ring and the elastic member, forcing the steel balls instantly separate from the insert grooves of the cylinder to release the large torque at once. Thus, the transmission gears and the shell may be protected from damaged, cracked or broken.

### BRIEF DESESCRIPTION OF DRAWINGS

This invention will be better understood by referring to the accompanying drawings, wherein;

FIG. 1 is a cross-sectional view of a conventional engine transmission system.

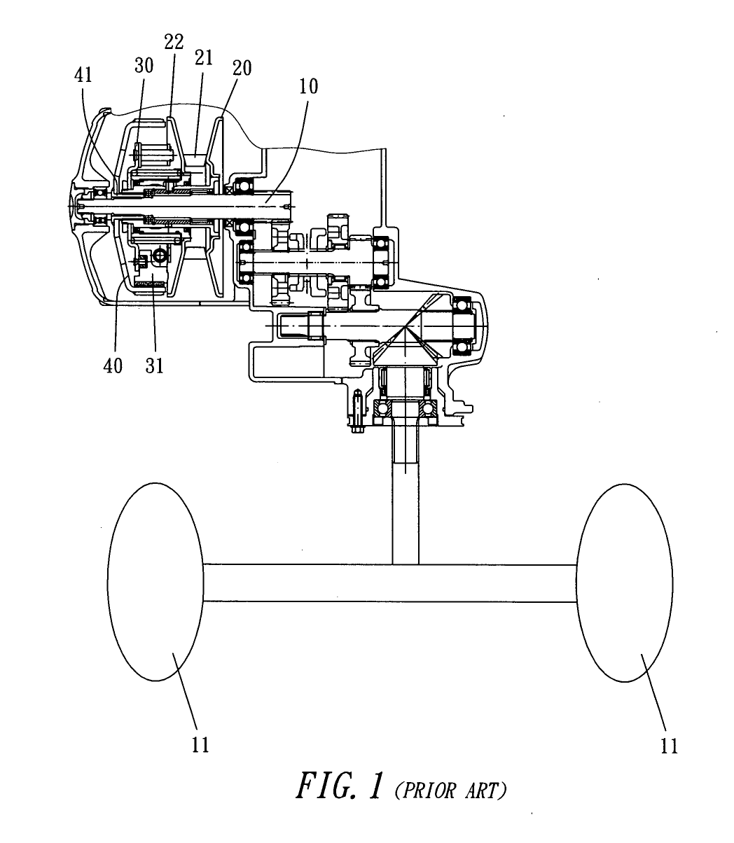

FIG. 2 is a partial magnified cross-sectional view of the conventional engine transmission system;

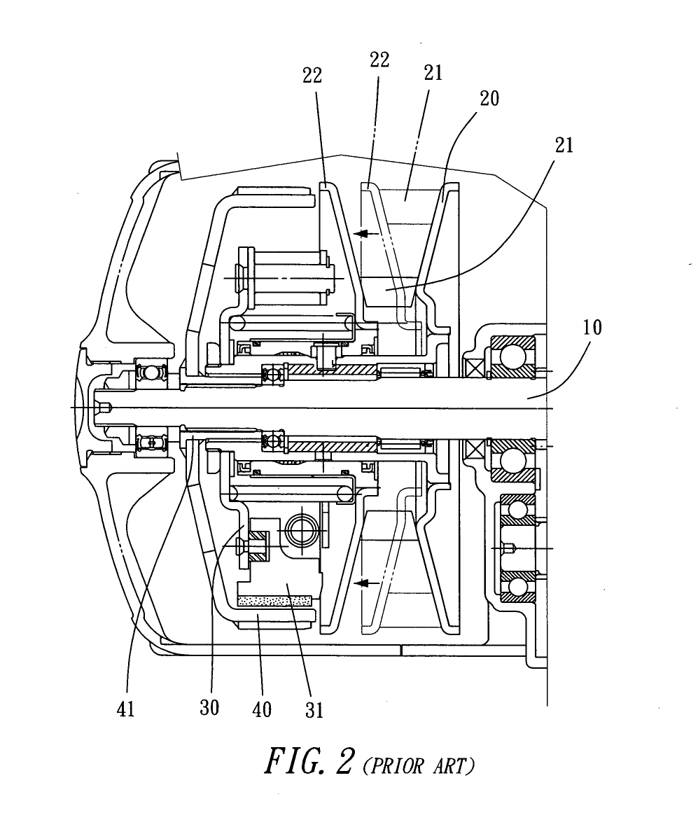

FIG. 3 is a cross-sectional view of an engine transmission system with a large torque diverting device in the present invention;

FIG. 4 is an exploded perspective view of the large torque diverting device in the present invention;

FIG. 5 is a cross-sectional view of the large torque diverting device under transmitting power in the present invention; and,

FIG. 6 is a cross-sectional view of the large torque diverting device under diverting condition in the present invention.

### DETAILED DESCRIPTION OF THE PREFERRED EMBODIMENT

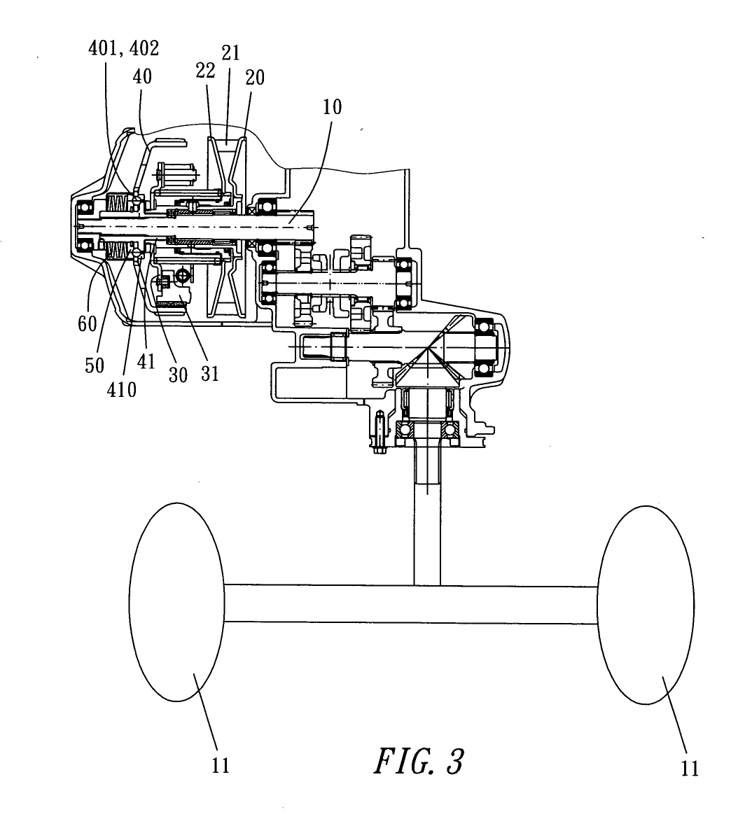

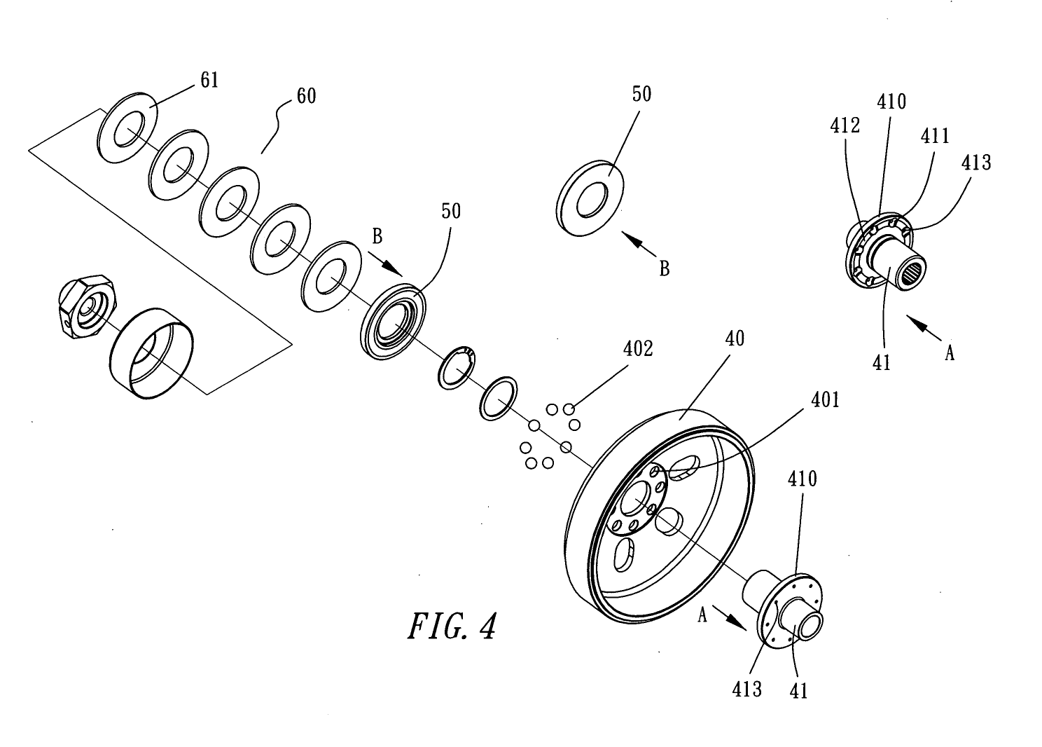

A preferred embodiment of a large torque diverting device for an engine transmission system in the present invention, as shown in FIGS. 3, 4 and 5, includes a drive shaft 10, a belt wheel 20 fixed around the drive shaft 10, a clutch 30, a bowl-shaped disc 40, and an intermediate cylinder 41 just as the conventional engine transmission system has. What is improved in this invention is to be described below.

The intermediate cylinder 41 has a flange 410 on its outer surface, a plurality of semi-circular insert grooves 411 spaced apart equidistantly in the flange wall, a recessed slide face 412 between every two insert grooves 411, a steel waste outlet 413 formed in the inner wall of every insert groove 411 for preventing steel waste from staying therein.

The bowl-shaped disc 40 is provided with through ball holes 401 to correspond to the insert grooves 411, and a steel ball 402 fitted in every ball hole 401.

Further, a push plate 50 and an elastic member 60 are provided, separated at the opposite side of the insert grooves 411 of the bowl-shaped disc 40. The elastic member 60 has some elasticity to push the push plate 50 toward the bowl-shaped disc 40 so as to force the steel balls 402 fitting in the through ball holes 401 and the insert grooves 411. Thus the cylinder 41 and the bowl-shaped disc 40 rotate together as integral. The elastic member 60 is composed of a plurality of thin disc-shaped metal rings 61 contacting with one another with back-to-back and front-to-front mode.

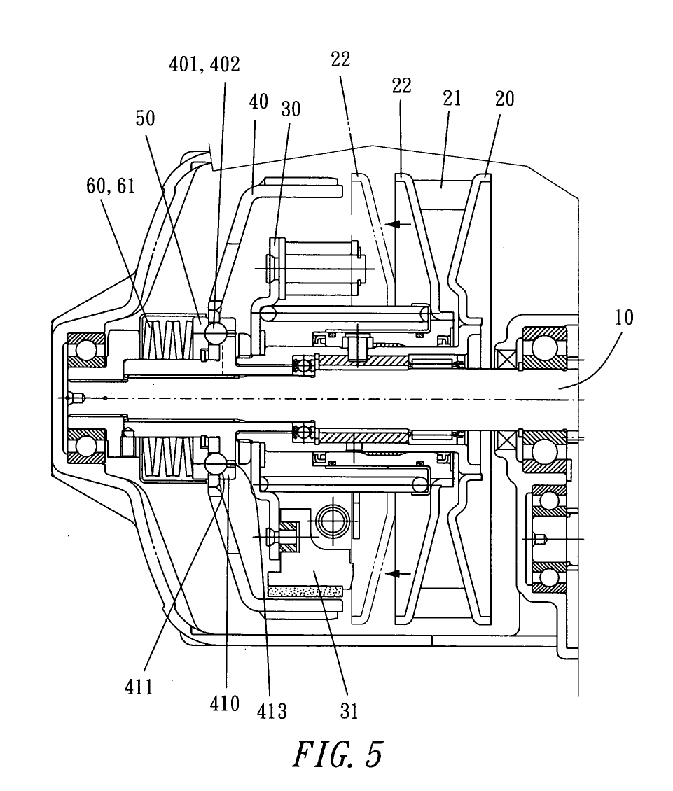

Next, the transmitting movement of this large torque diverting device is to be described. The transmitting order is the belt 21 to the belt wheel 20, then to the movable wheel surface 22, then to the clutch 30, then to the bowl-shaped disc 40, then to the steel balls 402, then to the flange 410, then to the cylinder 41, then to the drive shaft 10, and finally to the rear wheels 11, as shown in FIG. 5. The steel balls 402 are pushed by the elastic member 60 and the push plate 50 so they can be kept in the ball holes 402 and the insert grooves 411, forcing the bowl-shaped disc 40 rotate together with the cylinder 41 integrally.

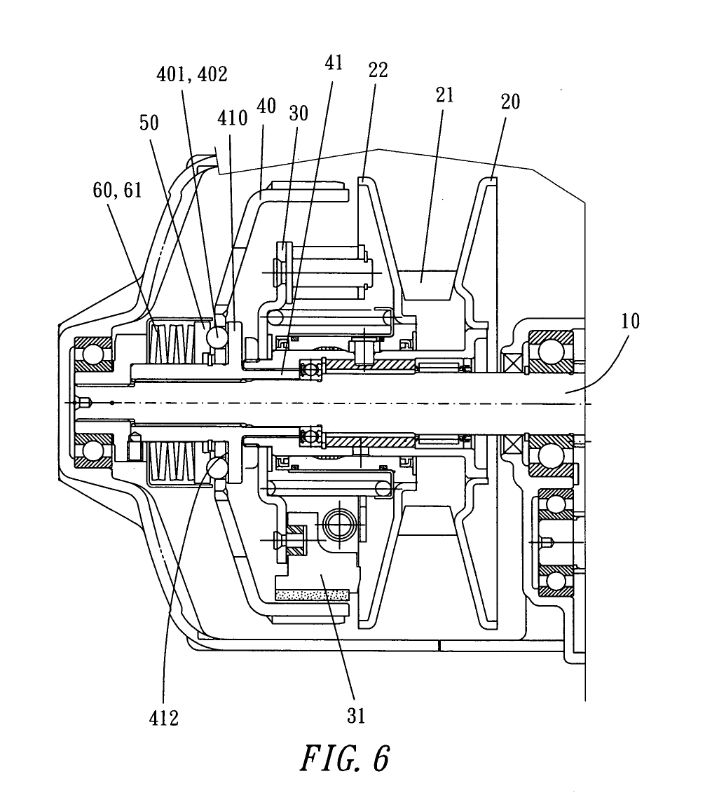

Next, if the rear wheels 111 receives a large load or a extraordinary shock and become deadlocked immovable, the cylinder 41 also kept immovable together with the drive shaft 10, but the bowl-shaped disc 40 may keep on rotating. Then the bowl-shaped disc 40 still moves the steel balls 402 to shift. As the cylinder 41 has its flange 410 immovable, as shown in FIG. 6, the steel balls 402 will compress the elastic member 60 and separate from the ball holes 402 and slide along the recessed slide faces 412 and shift to fit into the next ball holes 402, permitting the drive torque transmitted from the bowl-shaped disc 40 instantly released so that the cylinder 41 and the drive shaft 10 do not receive transmitted drive power. Therefore, the transmission gears and the shell may not receive the large torque, and subsequently may not be damaged or cracked.

In general, if the output side of the transmission system receives excessively large torque, the large torque diverting device can instantly function to let the large torque diverted to be released for protecting the transmission gears and the shell from damaged, cracked or broken, having a better advantage than conventional engine transmission system.

While the preferred embodiment of the invention has been described above, it will be recognized and understood that various modifications may be made therein and the appended claims may cover all such modifications that may fall within the spirit and scope of the invention.

What is claimed is:

1. A large torque diverting device for an engine transmission system, said device comprising a bowl-shaped disc, a drive shaft, and an intermediate cylinder positioned between said bowl-shaped disc and said drive shaft, said intermediate cylinder having a flange on its outer surface and a plurality of recessed insert grooves formed spaced apart equidistantly in the annular surface of the side of the flange wall facing said bowl-shaped disc, said bowl-shaped disc having plural through ball holes in the center portion to correspond to said insert grooves, said ball holes respectively having a steel ball fitting therein; an elastic member and a push ring provided to be located at the rear side of said bowl-shaped disc, said elastic member pushing said push ring to force all of said steel balls to partly insert in said insert grooves of said flange of said cylinder.

2. The large torque diverting device for an engine transmission system as claimed in claim 1, wherein each said insert groove of said flange of said cylinder is provided in its inner wall with a steel waste outlet.

3. The large torque diverting device for an engine transmission system as claimed in claim 1, wherein said flange of said cylinder has a recessed slide face between every two of said insert grooves.

4. The large torque diverting device for an engine transmission system as claimed in claim 1, wherein said elastic member is composed of a plurality of metal ring located with the back-to-back and front-to-front mode.
